(19) United States
(12) Patent Application Publication
(10) Pub. No.: US 2024/0261618 A1
(43) Pub. Date: Aug. 8, 2024

(54) AEROSOL FIRE-EXTINGUISHING AGENT COMPOSITION

(71) Applicant: YAMATO PROTEC CORPORATION, Tokyo (JP)

(72) Inventors: Shogo Tomiyama, Inashiki-gun (JP); Akimasa Tsutsumi, Inashiki-gun (JP); Takafumi Anezaki, Inashiki-gun (JP)

(73) Assignee: YAMATO PROTEC CORPORATION, Tokyo (JP)

(21) Appl. No.: 18/568,388

(22) PCT Filed: Jun. 2, 2022
(86) PCT No.: PCT/JP2022/022501

§ 371 Date: Dec. 8, 2023

(30) Foreign Application Priority Data
Jun. 9, 2021 (JP) 2021-096441

(51) Int. Cl. A62D 1/06

(52) U.S. Cl. CPC A62D 1/06

(57) ABSTRACT

Provided is an aerosol fire extinguishing agent composition which can be used as a fire extinguishing agent when a fire occurs. The aerosol fire extinguishing agent composition is characterized in that the amount of a fire extinguishing agent (fire extinguishing concentration of aerosol) required for fire extinguishing specified in a cup burner test is 1200-1800 g/m³.

### TECHNICAL FIELD

The present invention relates to an aerosol fire extinguishing agent composition which can suppress and extinguish a fire by generating an aerosol through combustion and an aerosol generating automatic fire extinguishing device using the same.

### BACKGROUND ART

Common fire extinguishers, fire extinguishing devices and the like are filled with a fire extinguishing agent in the powdery state. Basically, such fire extinguishers and extinguishing devices have a function that, when diffusing a fire extinguishing agent in a fine powder state toward the flame during operation, radicals such as potassium radicals are generated instantly, and the generated radicals catch the hydrogen radical, oxygen radical, hydroxyl radical and the like which promote the combustion reaction to extinguish the fire.

Since these fire extinguishers and fire extinguishing devices using powder type fire extinguishing agents diffuse the powder as it is, they need to be a large and bulky container, and since the powder is ejected instantly, the container should be a high-pressure resistant container, which becomes heavy.

Here, for example, in Patent Document 1 (Russian Patent No. RU2357778 C2), in order to realize a more compact extinguishing device, by using a pyrotechnic composition composed of dicyandiamide as a fuel component and potassium nitrate as an oxidizing component, it is possible to generate an aerosol containing a potassium radical derived from the oxidizing agent.

### PRIOR ART DOCUMENT

### Patent Document

Patent Document 1: Russian Patent No. RU2357778 C2

### SUMMARY OF THE INVENTION

### Problem to be Solved by the Invention

The present invention provides an aerosol fire extinguishing agent composition which can make a fire extinguisher, a fire extinguishing device or the like more compact and lightweight in comparison with the powder-type fire extinguishing agent, when using as the fire extinguishing agent for the fire extinguisher, the fire extinguishing device or the like, and an aerosol generating automatic extinguishing device using the aerosol fire extinguishing agent composition.

### Means to Solve the Above Problem

In order to solve the above object, the present invention provides an aerosol fire extinguishing agent composition characterized in that an amount of an extinguishing agent (aerosol fire extinguishing concentration) required for fire extinguishing specified in a cup burner test is 10 to 1000 g/m³.

In the aerosol fire extinguishing agent composition of the present invention, it is preferable to contain:
(A) an aerosol generating agent component containing at least one of ammonia, an alkali metal, an alkaline earth metal, and a halogen; and
(B) an oxidizing agent component containing at least one of a nitrate, a chlorate, a perchlorate, a peroxide, and a metal oxide.

In the aerosol fire extinguishing agent composition of the present invention, it is preferable that the aerosol generating agent component (A) is at least one of an ammonium compound, a fluoride, a chloride, a bromide, an iodide, a lithium compound, a sodium compound, a cesium compound, a magnesium compound, and a calcium compound.

In the aerosol fire extinguishing agent composition of the present invention, it is preferable that the oxidizing agent component (B) is at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

Further, it is preferable that the aerosol fire extinguishing agent composition of the present invention has an apparent density of 1.0 g/cm³ or more.

Furthermore, the present invention provides an aerosol generating automatic fire extinguishing device containing the aforementioned aerosol fire extinguishing agent composition of the present invention.

### Effects of the Invention

The fire extinguishing agent composition and the aerosol generating automatic fire extinguishing device using the same do not diffuse the powder as it is, but can generate an aerosol having an extinguishing ability which is ignited and burned automatically by the heat due to the fire. Therefore, it is possible to make an extinguisher, an extinguishing device or the like more compact and lightweight in comparison with the case where the powder-type fire extinguishing agent is used.

### BRIEF DESCRIPTION OF THE DRAWINGS

FIG. 1 is an explanatory diagram including a schematic configuration of the cup burner test device used for measuring the fire extinguishing concentration of the aerosol fire extinguishing agent composition according to the present invention.

FIG. 2 is a diagram for explaining the test method of a confirmation test of extinguishing test by using the aerosol fire extinguishing agent composition of the present invention (combustion space volume being 5 L).

FIG. 3 is an explanatory diagram including a schematic configuration of the cup burner test device used for measuring the fire extinguishing concentration of the conventional extinguishing gas agent.

FIG. 4 is an explanatory diagram including a schematic configuration of a comparative cup burner test device used for measuring the fire extinguishing concentration of the aerosol fire extinguishing agent composition.

FIG. 5 is an explanatory diagram including a schematic configuration of another comparative cup burner test device used for measuring the fire extinguishing concentration of the aerosol fire extinguishing agent composition.

### MODE FOR CARRYING OUT THE INVENTION

Hereinafter, an aerosol fire extinguishing agent composition and an aerosol generating automatic fire extinguishing device using the same according to a typical embodiment of the present invention will be described in detail with reference to the table. However, the present invention is not limited to these, and various design changes are possible, and all embodiments that have the technical matters described in the claims are included in the present invention.

### SUMMARY OF THE PRESENT INVENTION

The present invention relates to an aerosol extinguishing agent composition, and specifically, an aerosol extinguishing agent composition characterized in that an amount of an extinguishing agent (aerosol fire extinguishing concentration) required for extinguishing a fire specified in a cup burner test is 10 to 1000 g/m³ (more preferably 150 to 900 g/m³). Accordingly, the present invention also relates to a method for testing an aerosol fire extinguishing composition using the cup burner test method, as described in detail below.

The cup burner test is a method commonly used for testing the performance of fire extinguishing gases. A cup burner device that burns while supplying fuel in a prescribed manner maintains combustion while supplying air at a predetermined flow rate (for example, 40 ml/min) from an air cylinder, on the other hand, an extinguishing gas (aerosol in the description) is introduced into the same cup burner device from a fire extinguishing gas cylinder while changing a flow rate, and then, an amount of the fire extinguishing agent (aerosol extinguishing concentration) as the minimum amount of inflow at the time when the flame of the cup burner is extinguished is experimentally determined.

The fire extinguishing concentration is expressed by the equation.

Tc=100×Vf/(40+Vf).
wherein Tc (%) is the fire extinguishing concentration and Vf (ml) is the average amount of the extinguishing agent inflow at the extinguishing.

Since the object of the present invention is the aerosol extinguishing agent composition, in the description, the fire extinguishing concentration is determined by the aerosol rather than the extinguishing gas, and instead of the extinguishing gas cylinder, a combustion container that exothermically decomposes the aerosol generating agent is connected, and the extinguishing concentration was determined by conducting an experiment while obtaining the inflow amount from the weight change.

### DETAILED DESCRIPTION OF THE PRESENT INVENTION

### 1. Aerosol Fire Extinguishing Agent Composition

The aerosol fire extinguishing agent composition according to the present invention comprises (A) an aerosol generating agent component containing at least one of ammonia, an alkali metal, an alkaline earth metal, and a halogen; and (B) an oxidizing agent component containing at least one of a nitrate, a chlorate, a perchlorate, a peroxide, and a metal oxide.

The aerosol generating agent component (A) is a component for generating the aerosol by generating thermal energy through combustion together with the oxidizing agent component (B), in other word, a fuel, and contains at least one of ammonia, an alkali metal, an alkaline earth metal, and a halogen.

That is, the aerosol generating agent component (A) is one or more types containing at least one molecule or element of ammonia, an alkali metal, an alkaline earth metal, and a halogen.

Further, it is preferable that the aerosol generating agent component (A) is at least one of an ammonium compound, a fluoride, a chloride, a bromide, an iodide, a lithium compound, a sodium compound, a cesium compound, a magnesium compound, and a calcium compound.

Next, the oxidizing agent component (B) is a component for generating thermal energy through combustion together with the aerosol generating agent component (A), and contains at least one of a nitrate, a chlorate, a perchlorate, a peroxide, and a metal oxide.

Among them, it is preferable that the oxidizing agent component (B) contains at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

Here, the content ratio of the aerosol generating agent component (A) and the oxidizing agent component (B) is, based on the total amount of the aerosol generating agent component (A) and the oxidizing agent component (B) being 100% by mass, roughly as follows.

### Component (A):

10 to 70% by mass, preferably 20 to 60% by mass, more preferably 30 to 50% by mass

### Component (B):

30 to 90% by mass, preferably 40 to 80% by mass, more preferably 50 to 70% by mass.

The aerosol fire extinguishing agent composition according to the present invention may contain, in addition to the aerosol generating agent component (A) and the oxidizing agent component (B), additives which are necessary for molding, such as a binder, a plasticizer, and a release agent.

Furthermore, it is preferable that the aerosol fire extinguishing agent composition according to the present invention preferably contains a molding aid component (C) in addition to the aerosol generating agent component (A) and the oxidizing agent component (B). The molding aid component (C) is a binder, a plasticizer, a lubricant, or the like that is necessary for molding the aerosol generating agent component (A) and the oxidizing agent component (B), and may include, for example, any one of CMC-Na (carboxymethyl cellulose sodium salt), ethyl cellulose, PVA (polyvinyl alcohol), PVB (polyvinyl butyrate), PVP (polyvinylpyrrolidone), starch, guar gum, carrageenan, gum arabic, natural rubber, synthetic rubber, silica, alumina, mica, silica alumina, carbon graphite, stearate, and whisker, and preferable is CMC-Na.

The content ratio of the molding aid component (C) is 0.1 to 100 parts by mass with respect to 100 parts by mass of the total amount of the aerosol generating agent component (A) and the oxidizing agent component (B), preferably 0.6 to 50 parts by mass.

The aerosol fire extinguishing agent composition of the present invention has a thermal decomposition starting temperature in the range of over 90° C. to 260° C., preferably over 150° C. to 260° C. The thermal decomposition starting temperature can be met by combining the aerosol generating agent component (A), the oxidizing agent component (B), and the molding aid component (C) in the aforementioned ratios.

According to the composition of the present invention, when satisfying the aforementioned range of the thermal decomposition temperature, by receiving the heat during the fire without using an ignition device, or the like it is possible to automatically ignite and burn the aerosol generating agent component (A) and an oxidizing agent component (B) to generate the aerosol derived from the aerosol generating agent component (A) and then extinguish the fire.

Since an ignition temperature of ordinary wood as a flammable material in a room is 260° C., when setting the thermal decomposition temperature within the condition where the heat sensor would not be activated under the general operating temperature of the heat sensor of an automatic fire alarm system which is installed in a place handling fire, that is, 90° C. or low, it is possible to instantly extinguish the fire and prevent erroneous operation of the heat sensor. In particular, since the maximum setting temperature of the heat sensor is 150° C., high versatility can be obtained by setting the lower limit of the thermal decomposition starting temperature to over 150° C.

The manner of the composition of the present invention is not particularly limited, and may be a powder or a molded article of desired shape. The molded article may be in the form of granules, pellets of desired shape (columnar shape, etc.), tablets, spherical shapes, circular plates and the like. In the case of the molded article, an apparent density thereof is preferably 1.0 g/cm³ or more.

### 2. Aerosol Generating Automatic Extinguishing Device

The automatic extinguishing device of the present invention may be either in the form of a device which does not have an ignition means for igniting the aerosol generating agent, or in the form of a device which has a known initiation means such as an initiator or a detonator for igniting.

In the automatic extinguishing device according to the present invention, the automatic extinguishing device without the ignition means can be made in the form where the aerosol fire extinguishing agent composition of the present invention is contained in a combustible or incombustible container.

As the automatic extinguishing device, the device where the fire extinguishing agent composition of the present invention is contained in a combustible container can be used, for example, by throwing the whole of the aforementioned container into a flame.

On the other hand, when the automatic extinguishing device of the present invention is the device where the aerosol fire extinguishing agent composition of the present invention is contained in an incombustible container can be used, for example, by sprinkling the composition through the opening of the container to the igniting cooked contents (igniting contents in a pan, etc.).

Further, the automatic extinguishing device according to the present invention can be sensed fast and thus be used in a manner where the composition of the present invention is contained in a container made of a material having good thermal conductivity (aluminum, copper, etc.), and further, the container may have a fin structure for increasing the surface area in order to enhance heat collection effect. This automatic extinguishing device can be used, in order to deal with when a fire occurs due to an unlikely ignition, for example, by placing near various batteries.

The automatic extinguishing device having the ignition means may be a device where a container where the aerosol fire extinguishing agent composition of the present invention as a fire extinguishing agent and the ignition means are installed is combined with the heat sensor for transmitting the fire occurrence to the ignition means to operate.

### 3. Cup Burner Test Method

As mentioned above, the cup burner test is a method commonly used for testing the performance of fire extinguishing gases. A cup burner device that burns while supplying fuel in a prescribed manner maintains combustion while supplying air at a predetermined flow rate (for example, 40 ml/min) from an air cylinder, on the other hand, an extinguishing gas (aerosol in the description) is introduced into the same cup burner device from a fire extinguishing gas cylinder while changing a flow rate, and then, an amount of the fire extinguishing agent (aerosol fire extinguishing concentration) as the minimum amount of inflow at the time when the flame of the cup burner is extinguished is experimentally determined.

The fire extinguishing concentration is used to evaluate the extinguishing performance of gaseous extinguishing agents, and is the ratio of the agent (extinguishing agent composition, extinguishing gas) to air when the flame is extinguished in the cup burner test. The fire extinguishing concentration Te (%) is expressed by the following equation:

Te=100×Vf/(40+Vf),
wherein Vf (ml) is the average amount of the extinguishing agent inflow at the extinguishing.

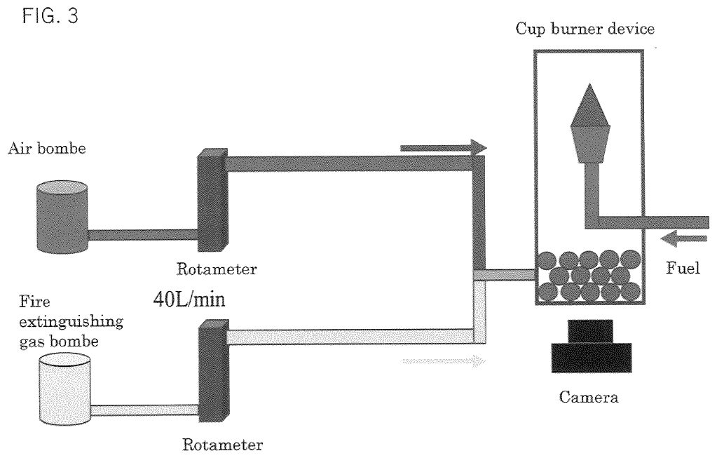

Here, although, in the conventional cup burner test, the device having the configuration shown in FIG. 3 is used, since the aerosol fire extinguishing agent composition according to the present invention cannot be supplied from a fire extinguishing gas cylinder but can be supplied through generation of self-burning, such conventional device cannot be used for the experiment in the first place. Therefore, the inventor studied first a method where an air supplied from an air cylinder was mixed with an aerosol generated by burning an aerosol fire extinguishing agent composition in a combustion container, and the resulting mixture was supplied to a cup burner device.

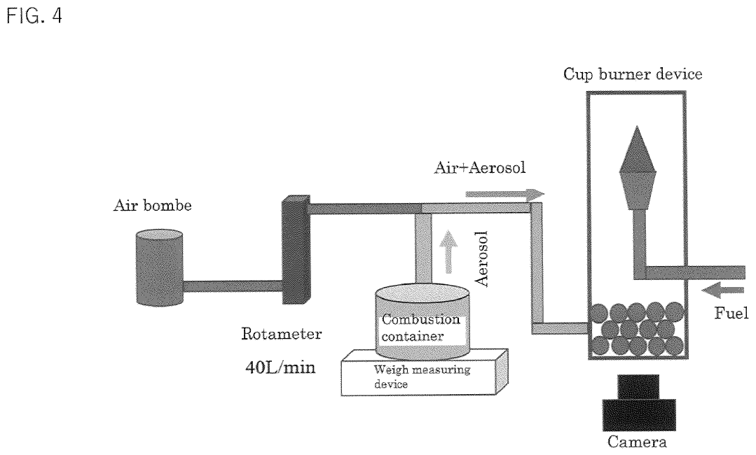

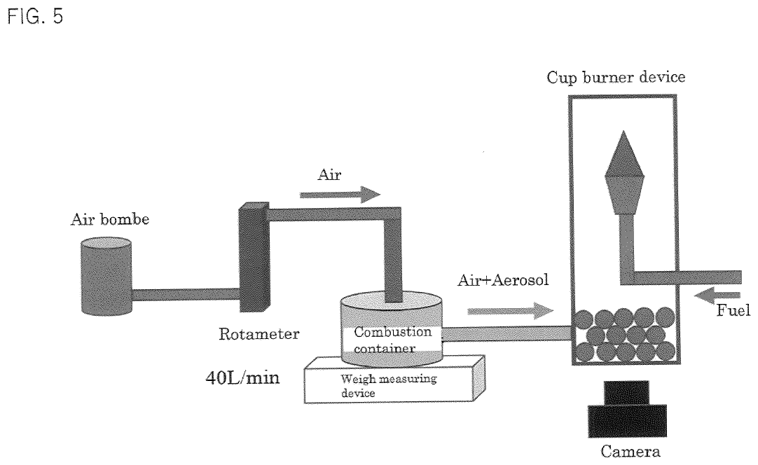

That is, in the comparative cup burner test device shown in FIG. 4, the aerosol generated in the combustion container (chamber) and an air are mixed in a branched line at the natural pressure during combustion of the aerosol fire extinguishing agent composition, and the mixture is supplied to the cup burner device. Further, in another comparative cup burner test device shown in FIG. 5, an air supply line is drawn into the combustion container (chamber), and the aerosol generated by burning the aerosol fire extinguishing agent composition in the combustion container is mixed with the air, and then the mixture is then discharged through another outlet and supplied to the cup burner device.

The interior volume of the combustion container is 0.75 L, a solid (pellet-like) test sample (sample) of the aerosol fire extinguishing agent composition is placed on a filter, and a heater is placed on top of the sample to burn it. Then, the mass change inside the combustion container is continuously measured (10 times/s) using a weighing scale. Further, the pressure inside the combustion container, the temperature inside the combustion container, and the temperature at the outlet of the combustion container are continuously measured (100 times/s) using a data logger.

However, when the device shown in FIG. 4 was used, both the mass flow rate and the aerosol concentration showed very high values, and abnormal fire extinguishing was observed. Since a large amount of the aerosol remained in the combustion container after the experiment, the reason was presumed to be that the aerosol could not be properly supplied to the cup burner device.

The experimental conditions are as follows.
Air volume flow rate: 40 L/min
Chamber internal volume: 0.75 L
Tube inner diameter: 4 mm
Sample diameter: 10 mm, 20 mm
Number of samples: 1, 3 (φ 10 mm)

Further, when the device shown in FIG. 5 was used, the aerosol concentration was measured within a predetermined range, and it was found that the mass flow rate could be controlled by adjusting the cross-sectional area of the solid (pellet-like) sample of the aerosol fire extinguishing agent composition, but, in some cases, the fire could not be extinguished.

The reason was presumed that the upstream flow rate decreased due to pressure fluctuation (increase) during combustion, and the aerosol was not sufficiently supplied.

The experimental conditions are as follows.
Air volume flow rate: 40 L/min
Chamber internal volume: 0.75 L
Sample cross-sectional area: 52.8 to 78.54 mm²
Number of samples: 1

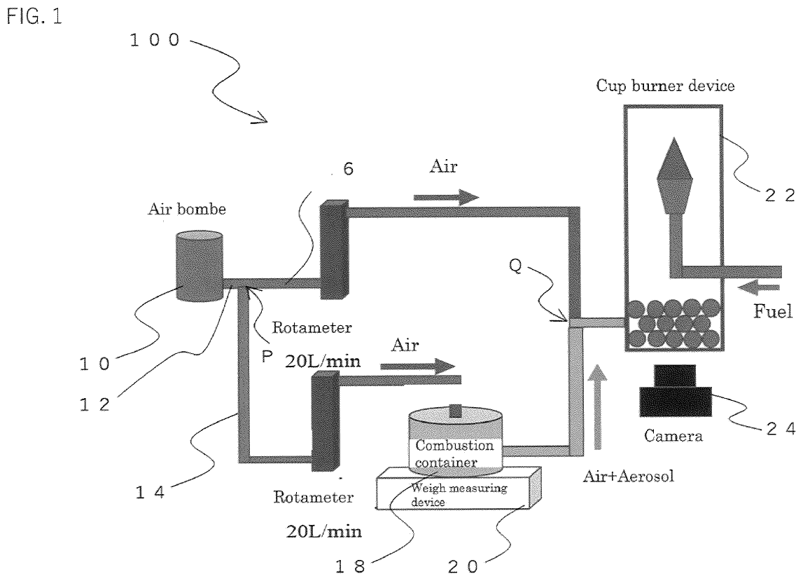

Accordingly, the inventors of the present invention thought that pressure fluctuation could be alleviated by reducing the flow rate of the air flowing into the combustion container, and created a device having the configuration in which the air supply line was divided into two, as shown in FIG. 1. In this device, the air is branched at a rate of 20 L/min, a combustion container is placed on one side, and then the air is merged.

When the device shown in FIG. 1 was used, the aerosol could be sufficiently mixed, and the phenomenon of fluctuation (reduction) in the upstream air flow rate was improved.

The experimental conditions are as follows.
Air volume flow rate: 20 L/min and 20 L/min
Chamber internal volume: 0.75 L
Sample cross-sectional area: 35.84 to 68.8 mm²
Number of samples: 1

Therefore, the present invention also provides a cup burner test device shown in FIG. 1, and also provides a method for measuring the fire extinguishing concentration of an aerosol fire extinguishing agent composition using the cup burner device.

In particular, the cup burner test device 100 according to the present invention has, as shown in FIG. 1, an air cylinder 10, a pipe (line) 12 extended from the air cylinder 10, a first pipe (line) 14 branched from the pipe 12 at the point P and a second pipe (line) 16, a combustion container 18 connected to the first pipe 14, and a weight measuring device 20 on which the combustion container 18 is placed. Then, at the point Q, the first pipe 14 and the second pipe 16 are configured to meet, and on the first pipe 14, the aerosol generated by combustion in the combustion container 18 and the air passing through the second pipe 16 is mixed, and the mixture is supplied to the cup burner device 22.

### EXAMPLE

### Examples 1 to 3 and Comparative Examples 1 to 3

Component (A), Component (B) and Component (C) shown in Table 1 were thoroughly mixed in the blending ratios (as dry matter not containing water and solvent) shown in Table 1, and an ion exchanged water equivalent to 10 parts by mass was added to 100 parts by mass of the total amount of Component (A), Component (B) and Component (C) and mixed to a water-moist mixture.

The obtained water-moist mixture was dried in a constant temperature oven at 110° C.×16 hours to obtain a dried product having a water content of 1% by mass or less. The thus obtained dried product was pulverized in an agate mortar and sized to a particle diameter of 500 μm or less to obtain a pulverized product.

Next, 2.0 g of the pulverized product was filled in a predetermined metal mold (die) having an inner diameter of 9.6 mm, and a punch was inserted, and a hydraulic pump pressurized with a surface pressure of 220.5 MPa (2250 kg/cm²), every 5 seconds by exerting pressure from both sides to obtain the molded articles of the aerosol fire extinguishing agent composition.

### [Cup Burner Test]

The cup burner test was conducted using the device shown in FIG. 1 according to the method described above to determine the fire extinguishing concentration. The results are shown in Table 1.

### [Fire Extinguishing Test]

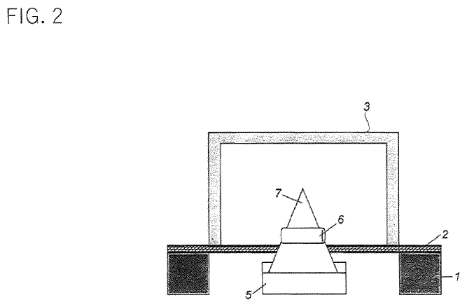

The test was carried out in the apparatus shown in FIG. 2. An iron wire mesh 2 was placed on a support desk 1, and the compositions (molded articles) 6 of Examples and Comparative Examples were placed in the center portion thereof. The wire mesh 2 was covered with a transparent container (5L) made of heat-resistant glass to seal the parts other than the part facing the metal mesh 2. A dish 5 containing 100 ml of n-heptane as an igniting agent was placed immediately under the composition 6 via the wire mesh 2.

In this manner, n-heptane was ignited to generate a flame 7, and the composition 6 was heated to generate an aerosol, and it was observed whether or not the flame 7 could extinguish. The results are shown in Table 1.

TABLE 1

| | | | | | | | Fire | Extinguishing Test | | |
|---|---|---|---|---|---|---|---|---|---|---|
| | Formulation | | | | | | extinguishing | | Extin- | |
| | Component | | | Component | | | conc. | Amount of | guished | |
| | (A) | | | (B) | | Component | (Cup burner | used | space | |
| | tripotassium | | | potassium | potassium | (C) | test) | composition | volume | Extin- |
| | citrate | dicyandiamide | nitrocellulose | chlorate | nitride | CMC—Na | (g/cm³) | (g/device) | (L) | guishment |
| Ex. 1 | 50.00 | — | — | 20.00 | — | 30.00 | 161.0 | 2.0/1 | 5 | Success |
| Ex. 2 | — | 30.00 | — | — | 60.00 | 10.00 | 24.0 | 2.0/1 | | Success |
| Ex. 3 | — | — | 30.00 | — | 60.00 | 10.00 | 823.0 | 2.0/1 | 5 | Success |
| Com. | 5.00 | — | — | 85.00 | — | 10.00 | 1250.0 | 2.0/1 | 5 | Failure |
| Ex. | | | | | | | | | | |
| Com. | 100.00 | — | — | — | — | — | 0 | 2.0/1 | 5 | Failure |
| Ex. | | | | | | | (aerosol was not | | | |
| | | | | | | | generated) | | | |
| Com. | — | — | — | 100.00 | — | — | 0 | 2.0/1 | 5 | Failure |
| Ex. | | | | | | | (aerosol was not | | | |
| | | | | | | | generated) | | | |

As can be seen from Table 1, in all cases where the aerosol fire extinguishing agent compositions according to Examples were used, fires could be extinguished instantly. Further, when the aerosol fire extinguishing agent compositions according to the Comparative Examples were used, although the fire temporarily became smaller, the fire could not be extinguished.

### INDUSTRIAL APPLICABILITY

The aerosol fire extinguishing agent composition of the present invention can be used as a fire extinguishing agent when a fire occurs.

### EXPLANATION OF SYMBOLS

1, 11: Support desk
2, 12: Wire mesh
3, 13: Container
5, 15: Igniting agent
6, 16: Fire extinguishing agent composition
7, 17: Flame

1. An aerosol fire extinguishing agent composition characterized in that an amount of extinguishing agent (aerosol extinguishing concentration) required for fire extinguishing specified in a cup burner test is 10 to 1000 g/m³.

2. The aerosol generating fire extinguishing agent composition according to claim 1, which comprises:
(A) an aerosol generating agent component comprising at least one of ammonia, an alkali metal, an alkaline earth metal, and a halogen; and
(B) an oxidizing agent component comprising at least one of a nitrate, a chlorate, a perchlorate, a peroxide, and a metal oxide.

3. The aerosol generating fire extinguishing agent composition according to claim 2, wherein the aerosol generating agent component (A) is at least one of an ammonium compound, a fluoride, a chloride, a bromide, an iodide, a lithium compound, a sodium compound, a cesium compound, a magnesium compound, and a calcium compound.

4. The aerosol generating fire extinguishing agent composition according to claim 2, wherein the oxidizing agent component (B) is at least one of ammonium nitrate, lithium nitrate, sodium nitrate, strontium nitrate, sodium chlorate, cesium chlorate, strontium chlorate, ammonium chlorate, magnesium chlorate, calcium chlorate, lithium perchlorate, sodium perchlorate, cesium perchlorate, magnesium perchlorate, strontium perchlorate, strontium peroxide, iron oxide, copper oxide, and molybdenum oxide.

5. The aerosol generating fire extinguishing agent composition according to claim 1, wherein an apparent density is 1.0 g/cm³ or more.

6. An aerosol generating automatic fire extinguishing device comprising the aerosol generating fire extinguishing agent composition according to claim 1.
